(19) United States
(12) Patent Application Publication
(10) Pub. No.: US 2017/0091733 A1
(43) Pub. Date: Mar. 30, 2017

(54) SENDING BILLS

(71) Applicant: Cardlink Services Limited, New South Wales (AU)

(72) Inventor: Keith Robert Goding Brown, New South Wales (AU)

(21) Appl. No.: 15/303,167

(22) PCT Filed: Apr. 11, 2014
(86) PCT No.: PCT/AU2014/000396

§ 371 Date: Oct. 10, 2016

(51) Int. Cl. G06Q 20/14; G06Q 20/08

(52) U.S. Cl. CPC G06Q 20/14; G06Q 20/085

(57) ABSTRACT

The disclosure concerns computing systems of financial institutions and computing systems that interact and support functions of financial institutions, including sending bills. The computing system receives from the biller, a communication address and billing data and determines based on the communication address a payer identifier and a payer institution. The computing system then sends the billing data associated with the payer identifier to the determined payer institution. Since the payer identifier and payer institution are determined based on the communication address, the payer can receive the bills without entering complicated data. A payer can easily remember the communication address, such as a phone number or email address, and therefore, determining the payer identifier and payer institution based on the communication address is more convenient than other systems that require the payer to enter complicated reference numbers.

### TECHNICAL FIELD

The disclosure concerns computing systems of financial institutions and computing systems that interact and support functions of financial institutions, including sending bills. The disclosure includes a description of methods, computer systems and software.

### BACKGROUND ART

Before online banking, payments of household bills, such as water, gas, electricity and telephone, were primarily made over the counter at the biller's offices, over the counter at the biller's financial institution (e.g. bank) or by cheque through the postal mail.

The launch of online payment systems, such as BPAY in Australia, began the era of customer convenience and choice in payment channels to pay bills. The BPAY payment system provides customers a simple electronic method of paying bills, irrespective of the biller's or payer's bank financial institution (FI). BPAY offers billers (i.e. businesses) a reliable, secure, electronic channel for receiving payments from customers,

Billers display the BPAY logo on their bills along with their biller code (i.e. biller identifier) and the customer reference number (CRN) that refers to the transaction. Payment transactions are initiated by payers from either telephone or internet banking platforms. The payer does not need to know the biller's FI as the BPAY payment system uses the biller code to route payment instruction to the biller's FI.

The CRN includes a ‘check digit’, this is a number that is calculated from the reference number using a check digit algorithm. The purpose of the check digit is to reduce the possibility of the payer accidentally transposing the numbers in the CRN when entering them into their banking interface. Thus if a payer enters a CRN with an invalid check digit the entry is rejected by the check digit algorithm. This approach leads to a higher level of accuracy when payers enter CRNs.

A BPAY payment transaction offers billers an electronic transaction with cleared funds that are not subject to chargebacks or dishonours.

The payer's FI immediately allocates the funds to the transaction. The transaction is batched by the payer's FI and sent to BPAY for inclusion in settlement processing for that night. Settlement between FIs is made the next business banking morning.

As BPAY payments are ‘pushed’ by the payer to the biller through the Australian banking network they are not processed through third party networks such as the international card scheme networks that attract usage fees.

Any discussion of documents, acts, materials, devices, articles or the like which has been included in the present specification is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated clement, integer or step, or group of elements, integers or steps, but not the exclusion of any other element, integer or step, or group of elements, integers or steps.

### SUMMARY

A computer implemented method for sending bills from a biller to a payer comprises:
receiving from the biller a communication address and billing data;
determining based on the communication address a payer identifier and a payer institution; and
sending the billing data associated with the payer identifier to the determined payer institution.

Since the payer identifier and payer institution are determined based on the communication address, the payer can receive the bills without entering complicated data. A payer can easily remember the communication address, such as a phone number or email address, and therefore, determining the payer identifier and payer institution based on the communication address is more convenient than other systems that require the payer to enter complicated reference numbers. As a further advantage, the error rate for entering the communication address is far less than for entering reference numbers which appear meaningless to the payer.

The method may further comprise:
receiving from the biller a customer identifier; and
storing an association between the payer identifier, payer institution and the customer identifier to allow the biller to provide billing data associated with the customer identifier to the payer through the billing services hub.

The method may further comprise
receiving from the biller a biller identifier,

wherein storing the association comprises storing an association of the payer identifier, payer institution and the customer identifier with the biller identifier.

The method may further comprise sending to the payer institution a registration confirmation message comprising the payer identifier, the customer identifier and the biller identifier.

Receiving the communication address may comprise:
receiving a billing data message comprising a payer identifier field; and
determining the communication address based on a value of the payer identifier field.

The method may further comprise;
detecting an indicator that the value of the payer identifier field comprises a communication address; and
selectively determining the communication address where the indicator is identified.

The method may further comprise:
receiving a communication address from the payer associated with a payer identifier and a payer institution; and
storing an association between the payer identifier, the payer institution and the communication address.

The method may further comprise:
determining whether the communication address received from the payer is already stored; and
selectively performing the step of storing the association where the communication address is not already stored.

Receiving the communication address from the payer may comprise receiving a biller registration request message from the payer comprising a biller identifier field, and the method may further comprise selectively performing the step of storing the association between the payer identifier, the payer institution and the communication address based on a value of the biller identifier field.

Receiving the communication address from the payer may comprise receiving a biller registration request message from the payer comprising a customer identifier field; and determining the communication address based on a value of the customer identifier field.

The method may further comprise sending a confirmation message to the payer institution that the communication address has been stored.

Software, that is, computer readable instructions stored on computer readable media, when executed by a computer causes the computer to perform the method above.

A computer implemented billing services hub for sending bills from a biller to a payer comprises:
an input port to receive from the biller a communication address and billing data;
a processor to determine based on the communication address a payer identifier and a payer institution; and
an output port to send the billing data associated with the payer identifier to the determined payer institution.

A billing services computer system for controlling sending of bills comprises:
a persistence layer to store a status for the sending of bills and user data including a payer identifier, communication address and associated payer financial institution (FI);
a communication and mediation layer to receive an output message from a service layer, to send the output message to a recipient, to receive an input message from a sender, to validate the input message and to send the input message to the service layer; and
the service layer
   to receive the input message from the communication and mediation layer,
   where the input message includes an initial communication address storage request, to determine the payer identifier, the payer FI and the communication address based on the input message, to store in the persistence layer the communication address associated with the payer identifier and the payer FI and to set the status in the persistence layer to waiting for registration request from a biller,
   where the status is waiting for registration request from a biller and the input message comprises a registration request from the biller including a communication address and a customer identifier, to determine the payer FI based on the communication address in the registration request and based on information stored in the persistence layer, to store in the persistence layer an association between the customer identifier and the payer FI and to set the status in the persistence layer to waiting for billing data, and
   where the status is waiting for billing data and the input message comprises billing data from the biller, to determine the payer FI associated with the communication address in the persistence layer, to create the output message having the payer FI as recipient and including the billing data, and to send the output message to the communication and mediation layer.

Optional features of the first aspect set out above are also optional features of the other aspects where appropriate.

### BRIEF DESCRIPTION OF DRAWINGS

Examples will now be described with reference to the accompanying drawings in which:

FIG. 1 illustrates a bill payment network.

FIG. 2 schematically illustrates the method of the first example.

FIG. 3a illustrates an address table.

FIG. 3b illustrates a registration table.

FIG. 4 illustrates the hub of FIG. 1 in more detail.

FIG. 5a illustrates a state transition diagram.

FIG. 5b illustrates a transaction table.

### BEST MODE

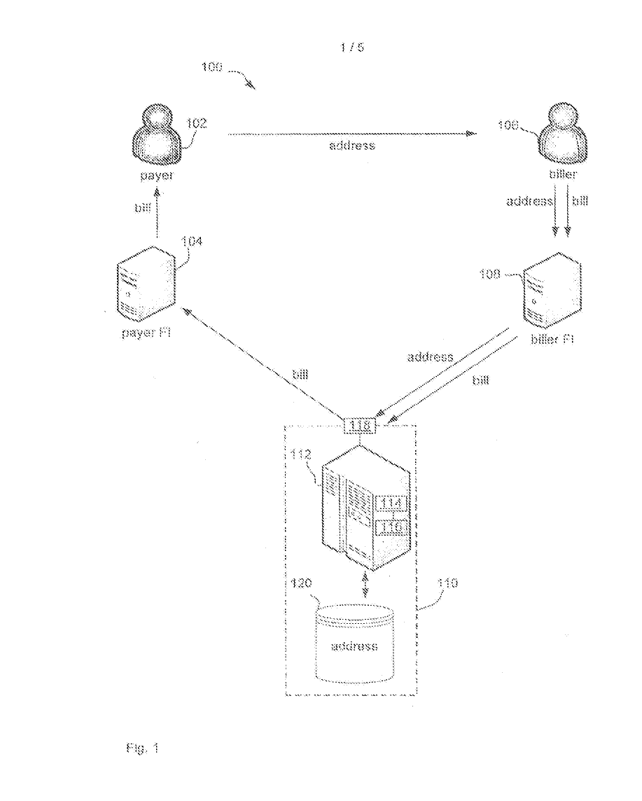

FIG. 1 illustrates a financial grade bill payment network 100 comprising a payer 102 who has one or more accounts with a payer financial institution (FI) 104. The payer may be a consumer of goods or services, such as utilities or mobile phone contracts. The account is associated with the user by a user identifier set by the payer FI 104, such as an account number. The user 102 purchases goods or services from biller 106, who also has one or more accounts with a biller FI 108 and the biller 106 creates a corresponding bill.

The biller 106 may then provide the payer 102 with the bill including the biller's 106 account information so that payer 102 can pay the bill by entering the biller's 106 account information into the online banking website of the payer FI 104. However, errors are likely and payer 102 will likely be dissatisfied with spending time to enter all the information, especially in cases where subsequent bills from the same biller 106 are to be paid and the biller information needs to be entered multiple times.

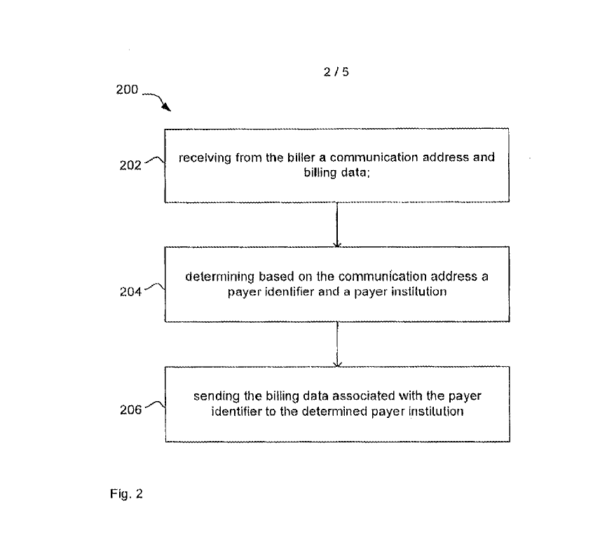

More conveniently, the biller 106 may be registered with a billing services hub 110 over the Internet or other wide area networks (WANs) via a data input/output port 118, such as an Ethernet port. The hub 110 comprises a server 112 having a processor 114 connected to program memory 116. The server 112 is connected to computer storage 120, such as non-volatile memory constituting a data base. Software or program code, that is, computer-executable instructions, is stored on program memory 116 and executed by processor 114, which throughout this specification may be referred to as the hub 110, the server 112 or the processor 114 performing a particular action, such as the method described with reference to FIG. 2.

The payer 102 is also registered with the hub 110 via payer FI 104. In this example, identifiers for the individual payers, such as payer 102, are set by their respective payer FIs. As a result, these identifiers may not be unique as different payer FIs may assign the same identifier to different individual payers. However, hub 110 maintains a database of payer FIs and creates and stores for each payer FI a unique FI identifier. This way, the combination of payer FI identifier and payer identifier is unique. In one example, hub 110 has the payer FI identifier included within the payer identifier, as the first three characters. So while the last 9 digits may be the same at different banks, the payer FI identifier at the front, counted as a part of the payer identifier, makes it unique. Hub 110 further generates and stores a unique biller identifier for each biller.

The payer 102 has an account with the biller 106 and the biller creates and assigns a customer identifier for payer 102. Again, this customer identifier may not be unique as different billers may assign the same customer identifier to different individual payers. However, the combination of customer identifier and biller identifier is unique.

When payer 102 registers to receive bills from biller 106, such as by entering the biller's 106 biller identifier and the payer's 102 customer identifier with that biller into the online banking website of payer FI 104, payer FI 104 sends a request message to hub 110. Hub 110 receives the request message and after verification with biller 106 stores the combination of the payer FI identifier and the payer identifier (set by the payer FI 104) associated with the combination of biller identifier and customer identifier (set by the biller 106) on database 120. As mentioned before, the payer identifier may contain the payer FI identifier such that huh 110 only stores one value.

The biller 106 can now provide one or more bills to the hub 110 and the bills contain the customer identifier and the biller identifier. From database 120 processor 114 can determine the payer FI and payer identifier associated with that customer and that biller based on the earlier registration. The payer FI 104 regularly requests billing data from hub 110 and as a response hub 110 sends all bills for that payer FI together with the payer identifiers to payer FI 104. The payer identifier can be related to individual payers 102 by payer FI 104 and therefore, the bills can be provided to the correct recipients.

The payer 102 may be informed by the payer FI 104 that a new bill has arrived. The payer 102 may then log into the banking website of payer FI 104 and conveniently initiate payment of that bill without entering further information about the bill, such as biller identifier, amount or biller FI identifiers.

While this solution is more convenient than receiving paper bills by post or receiving an electronic bill via email directly from the biller 106, there is still the inconvenience and risk for errors when the payer 102 enters the biller identifier and customer reference number from the bill into the online banking website of the payer FI 104. Further, the registration process is initiated by the payer 102 before the biller 106 sends an electronic bill to payer 102.

A more convenient and less error prone procedure is disclosed where the payer 102 provides a communication address to the biller 106, such as by entering a mobile phone number into an online shopping website. The mobile phone number is registered with the hub 110, such that the biller 106 can send bills through the hub 108 by providing the mobile phone number of the payer 102 to the hub 110. In order to allow the forwarding of bills through the hub 110, the hub 110 maintains an address database including an association between the mobile phone number and the combination of payer FI and payer identifier.

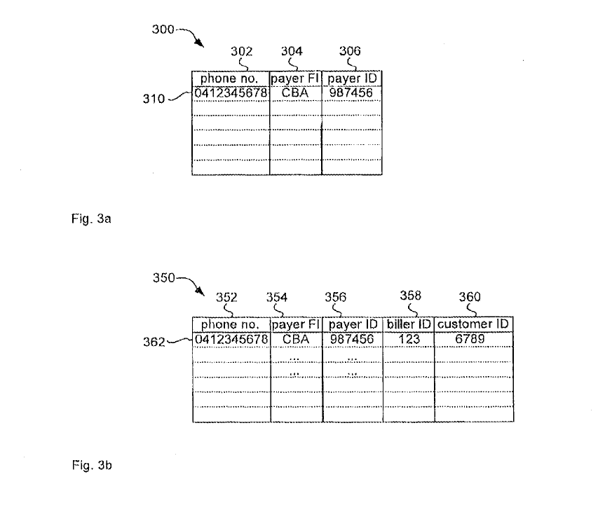

FIG. 3a illustrates an address table 300 of the address database. The address table 300 comprises columns or data fields for phone number 302, payer FI 304 and payer identifier 306, respectively. Address table 300 of FIG. 3a stores one address record 310 but of course, typically many hundred or even million records may be stored. The address table 300 may be implemented as part of an SQL database, such as database 120. Processor 114 can perform a query comprising the phone number 302 in order to determine the payer FI 304 and the payer identifier 306.

FIG. 2 illustrates a method 200 for sending bills as performed by processor 112 of billing services hub 108. Processor 112 receives 202 from the biller 106 a bill summary record comprising a communication address and billing data. The communication address may be a mobile phone number, landline number, email address or postal address. The billing data may comprise a single or multiple bills, which may be pdf documents, image data of scanned bills, XML files, rich text files or other forms of information. In one example, the communication address is included in the bill or is received as metadata to the bill.

As shown in FIG. 1, the communication address and the billing data may not be received directly from the biller 106 but via the biller FI 108.

Based on the communication address, the processor 112 determines 204 a payer identifier and a payer FI, such as by querying address table 300. As already described above, in this example, the payer identifier is set by the payer FI 104, which means the payer identifier alone may not be unique over all payers registered with the hub 108. However, the determined payer FI together with the payer identifier is unique. It is to be understood that although in these examples combinations of payer identifier and payer FI identifier are used as well as combinations of customer identifier and biller identifier, in other examples, the customer identifier and the payer identifier may be unique across the system and within hub 110, such that they can be used directly to identify an individual payer 102.

Then, the hub 110 sends 206 the billing data associated with the payer identifier to the payer FI 104. Since the payer FI 104 has set the payer identifier, such as an account number with the payer FI 104, the payer FI 104 can resolve the payer identifier and allocate the billing data to the correct payer 102.

The hub 110 allows the registration of the payer to receive bills from a biller 106 without the payer 102 having to provide biller information to the hub 110. This registration may be initiated by the biller 106 explicitly by sending a registration request message or implicitly by sending a bill summary record the first time.

This message contains the communication address and processor 114 determines the payer identifier based on registration data on database 120. The message further contains a customer identifier for payer 102 created and assigned by the biller 106. Processor 114 stores on database 120 an association of the determined payer identifier and payer FI with the customer identifier. This allows the biller 106 to provide billing data associated with the customer identifier to the payer through the hub 110 because now the customer identifier is registered and processor 114 can determine the payer identifier and payer FI identifier using the customer identifier and biller identifier.

In one example, the message from the biller 106 also includes a biller identifier and the above mentioned association stored on database 120 may also include an association of the payer identifier, the payer FI and the customer identifier with the biller identifier. The biller identifier may also be forwarded to payer FI 104 together with the payer identifier and the customer identifier to allow payer FI to also keep a record of the registration of payer 102 with that particular biller 106.

FIG. 3b illustrates a registration table 350 which may also be hosted by database 120. Registration table 350 comprises fields for phone number 352, payer FI 354, payer identifier 356, biller identifier 358 and customer identifier 340. Registration table 350 comprises one entry 362, which indicates that the above process for registering payer 102 with biller 106 has been successful and the association between these data fields has been stored on database 120. As can be seen in FIG. 3b, processor can query registration table 350 by providing the biller identifier and the customer identifier to obtain the payer identifier and the biller identifier in order to send bills from the biller 106 to the payer 102.

In some example scenarios, it may be an advantage to not introduce a new message type for registration as initiated by the biller 106 but instead, to use a billing data message with a payer identifier field for registration. However, when payer 102 purchases goods or services form biller 106, biller 106 does not yet know the payer identifier in order to fill that field. But often biller 106 has a communication address of the payer 102 available. Therefore, biller 106 sends the billing data message but instead of using the actual payer identifier in the payer identifier field of the billing data message, the biller 106 includes the provided communication address in the payer identifier field.

Hub 110 receives the billing data message and determines the communication address based on the value of the payer identifier field. This determining step may simply comprise reading the value into memory and using the value as the communication address or may comprise truncating the value or decrypting the value if the communication address is not transferred in plain text.

In one example, the payer identifier field comprises a flag that serves as an indicator to indicate that the payer identifier field comprises a communication address. The indicator may be a particular string, such as #ADDR# that has been provided to the biller previously. Processor 114 detects the indicator and selectively determines the communication address from the value of the payer identifier field where the indicator is identified.

If the indicator is not identified and a payer identifier as given in the payer identifier field is not registered, the hub 110 sends an error message to the biller 106.

While the above description explains how registration as initiated by the biller 106 is performed, the following description explains how initial registration of the communication address as supplied by the payer 102 is performed.

The payer 102 decides to provide a communication address in order to receive bills more conveniently and without registering each biller individually. Payer 102 therefore visits art activation website, which may be integrated into the online banking website of payer FI 104. Payer 102 provides login details, such as username and password, which are used by payer FI to identify an account and a payer identifier for payer 102. Payer FI 104 then receives the communication address from payer 102 and sends an initial registration message to the hub 110. The initial registration message comprises the communication address provided by the payer 102, the payer identifier and the payer institution, such as by including a payer institution identifier or name of the payer institution.

Hub 110 receives the initial registration message comprising the payer identifier, communication address and payer institution and stores an association between the payer identifier, the payer institution and the communication address on database 120, such that processor 114 can look up the payer institution and payer identifier by providing the communication address. The result of storing the communication address can be seen in FIG. 3a and has already been described above.

In one example, hub 110 avoids duplication of records with identical communication addresses in address table 300 by first determining whether the communication address received from the payer is already stored in address table 300. If the communication address is not already stored, processor 114 stores the association, and if it is already stored, hub 110 sends a corresponding error message to payer FI 104.

Similar to the examples described above where existing message types are used, in this scenario of initial storage of the communication address, an existing message type may also be used. In that case, payer FI 104 sends a biller registration request message although neither the payer FI 104 nor the payer 102 know which biller to register at this stage. The biller registration request message comprises a biller identifier field and the payer FI 104 enters a previously defined indicator value, such as “88888”, which may be identical for all payer FIs and all such processes, into this field to mark this message as an initial communication address storage request.

Processor 114 receives the biller registration request message and examines the value of the biller identifier field. If the provided value is identical to the previously defined indicator value, processor 114 stores the communication address in address table 30U on database 120. If the provided value is not identical to the indicator value, processor 114 treats this message as a regular biller registration request message.

In addition to the biller identifier field, the biller registration request message may comprise a customer identifier field, such that payer 102 can receive the customer identifier from the biller 106 and provide the customer identifier to the hub 110 in the customer identifier field. However, the customer identifier may not be known as this process is performed before the payer 102 purchases the goods and services from the biller 106.

Instead, payer FI 104 includes the communication address as the value of the customer identifier field. Processor 114 receives the biller registration request message from the payer 102 via the payer FI 104. Receiving ‘from the payer’ may comprise the payer 102 initiating the request and the payer FI 104 generating the actual message or the payer FI 104 automatically generating the message on the payer's 102 behalf. Since the message is associated with the payer 102 in these cases, the message is said to be received ‘from the payer’.

After processor 114 identifies based on the value of the biller identifier that the biller registration request message is used to provide the communication address, processor 114 determines the actual communication address based on the customer identifier field.

Once the communication address is stored on address table 300, hub 110 sends a confirmation message to the payer FI 104 that the communication address has been stored. That way the payer FI 104 can also log which communication addresses of its customers arc stored on hub 110.

In one example, messages sent to or from the I/O port 118 are comprised of data wrapped in XML.

Each message associated with the same transaction includes a unique transaction identifier allowing the different parties to associate subsequent messages received and sent relating to the particular transaction. For example, if the transaction is the sending of billing data, then the billing data message and confirmation message include the same transaction identifier.

Throughout this document, the word “transaction” is not limited to actions that result in transfer of funds, such as payments. Transactions comprise multiple steps of communication between the different parties involved. In one example, the transaction is the registration of a payer to receive bills from a biller as performed by the billing services hub 108.

The payer 102 and the biller 106 may be an individual, such as a natural person, or non-individual, such as a company.

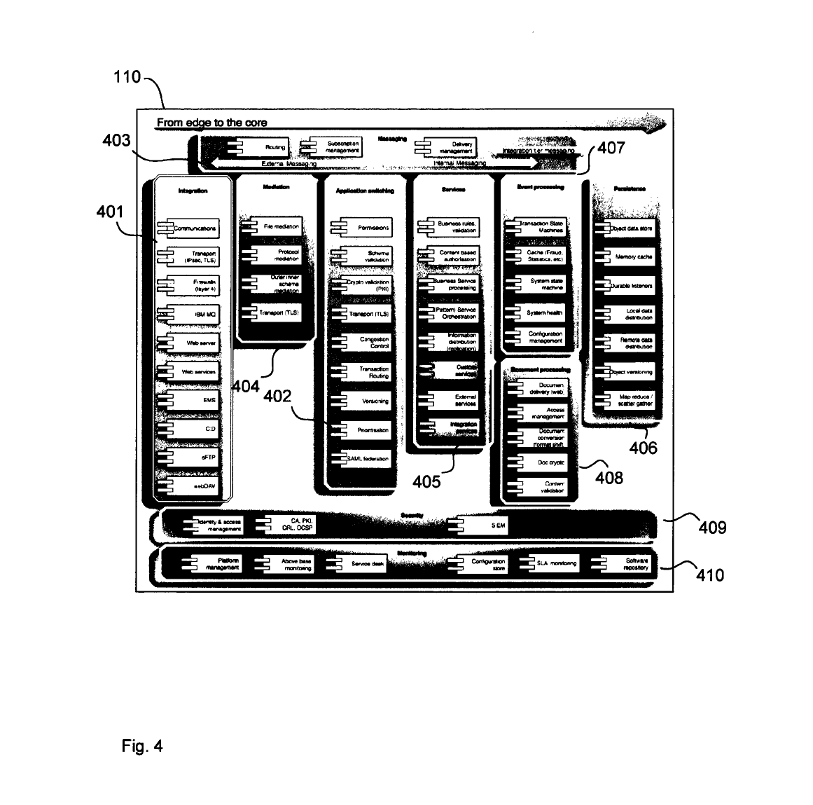

FIG. 4 illustrates the hub 110 in more detail in form of an application layer decomposition by functionality. One of the layers comprised by the hub 110 is an integration layer 401. This layer is the application gateway into the hub 110. In the OSI stack this translates into all communication from layers 4 to 7. This includes name services (DNS), including proximity and topology based DNS resolution of system resources for the clients. This is achieved by the global traffic manager (GTM) functionality of the F5 Big-IP platform. Resource based load balancing is implemented within the hub 110, where incoming connection requests are directed to the application host. This redirection can be based on application specific service matrix, including, sticky, round-robin or least count etc.

This layer allows to better manage the resources as well as, in event of an application node failure, it also allows to seamlessly re-direct the request to surviving application nodes. The integration layer 401 also comprises IBM MQ Services, including Queue management, routing, recovery, redundancy of traffic using IBM MQ application.

The hub 110 hosts its own queue manager framework. The queue manager provides the low level technical ack, nack and time-outs functionality. Web services, for synchronous communication are also integrated into the integration layer 401. Web services are screened for security issues using the Application Security Manager (ASM) from the F5 Big-IP product modules. The integration layer 401 further comprises web servers for all web requests for document retrieval as well as file upload, download for bulk file integration using Web-based Distributed Authoring and Versioning (WebDAV) method. Connect:Direct and Secure Shell File Transfer Protocol (sFTP) is used for the file transfers. All file transfers are managed from network file shares. The file mediation services in the mediation layer make use of the file system events to initiate the file processing. This is more efficient then polling a file system.

Hub 110 further comprises an application switching layer 402 performing the functionalities of content based routing, message validation services and Security Assertion Markup Language (SAML) federation.

The application switching layer 402 routes messages based on “affinity” where functions are stateful, such as complex event processing functions. For example, a transaction involving a 3-party pattern should be processed at a single service tier. However, messages from participants may be delivered to via any data centres of the hub 110 or components within the data centres.

In the distributed hub 110 a message related to a transaction may be received by a location or stack not processing the specific transaction. The application switching layer 402 will identify the correct processing stack and route the message over. The routes of the messages are based on version of the schema used.

The application switching layer 402 prioritises messages based on importance of a message at a business layer, such as a block address request as part of fraud management.

The application switching layer 402 provides message validation services for confidentiality and assurance (decryption, encryption, signing, signature validation), access control (permissions and roles), technical validations (e.g., XML wellformedness) and business validations (higher level validations, if any) and SAML federation. This is used for processing document retrieval requests received by the hub 110. It involves validation of the assertion, invoking request to the back-end services and coordination of the response including additional SAML assertions to the caller.

Hub 110 also comprises a messaging layer 403. The messaging layer 403 is a distributed high speed messaging tier that allows for very low latency and asynchronous message exchange in a reliable fashion. In line with the N+1 design principles, the messaging grid will autonomously recover from component failures. Each messaging server has a warm standby which allows for near instantaneous and stateful recovery with zero data loss. The messaging functionality includes queue, topics and subject based communication as well as integration with presence—for example based on Extensible Messaging and Presence Protocol (XMPP) or Remote Authentication Dial In User Service (RADIUS) events for end-point detection for transmission. The messaging functionality also includes message routing within and across the stacks and message level priority management and congestion control.

Three distinct messaging layers operate across the hub 110; external messaging, internal messaging and integration messaging. These layers are based on three distinct security zones. There is an additional messaging service used by the monitoring services.

Each messaging layer is to support the application services hosted at that tier and typically align with the security zones. There is no message routing crossing the security zone. All messages crossing the security zones will always go through a mediation layer 404.

Mediation layer 404 comprises message transformation services to transform messages from external to internal or vice-versa or from external to external.

The mediation layer 404 also comprises orchestration functionality for integration with the core of the hub 110, detection of duplicates, stripping or documents and integration of document processing, bulk file iteration and response collator integration.

An internal facing mediation tier provides integration with settlement engine, which includes real time messaging integration for continuous streaming of information as the transactions take place and once a day files processing such as updates to Biller Master File (BMF). The internal facing mediation tier also provides integration with an Ops Portal that also includes file transport functionality where members can submit instructions by Bulk file and collect responses to the bulk files submitted by them. The internal facing mediation tier further provides billing and business intelligence.

Hub 110 further comprises a service layer 405. This layer is where bulk of service functions are orchestrated based on the needs of various patterns. The services also include functionality for error correction, capturing errors and compensating actions. Some of the service functions will be bespoke to meet specific requirements. These include creation of the user identifier, transaction reference, universally unique identifier (MID) generation with site affinities, etc. The services are hosted within the enterprise service bus (ESB) and communicate using messaging layer. The service layer is stateless while orchestrations are stateful. Complex event processing systems are used to manage and maintain the states as well as the state transformation machines.

One of the key functions hosted out of the services layer is integration with a persistence layer 406. The persistence 406 is provided by a Data Grid. The data access is abstracted at the service bus. The data access functions facilitate replication of data across all data grids where replication is addressed as part of the business transaction. This allows provisioning of additional system capacity in a near linear scalable fashion. Additional capacity can also be provisioned on demand. This design approach also allows for quick re-purposing of capacity for other functions. For example, the document rendering/processing capacity could be increased during end of the financial year period for capacity and service level management.

The hub 110 has several service busses to meet requirements in different security zones:
a) External Demilitarized Zone (DMZ), to allow for functions such as duplicate transaction detection, enforcement of allowable usage types, and address allocation maps.
b) Document processing, to allow for all orchestration to process, store and retrieve documents. There are a few integrations with bespoke code, and appliances.
c) Internal, will include all other technical services. The internal services includes where orchestrations span stacks and/or sites. Orchestration across stacks, sites may be used where replication is part of business transaction.

Another layer within the hub 110 is an events processing layer 407 which is the control tier of the hub 110 applications. One of the core functions that this application layer provides is managing and maintaining transaction states. This is achieved by state-transition-machines. State machines are defined for each transaction flows. It is the state machine that orchestrates the transactions provides event correlation with the other components of the hub 110 such as document processing provides the time-based event processing for TTRs.

The state machines arc typically initialised by the first message/event in a transaction or instruction received by the hub 110. Subsequent processing and functions performed on the transaction result in events being generated. These events are relayed back to the state machine and based on the event it undergoes state changes. Once a transaction is complete and committed, the state machine is destroyed.

The event processing engine is also used for real-time collection of intelligence, such as fraud and statistical data generation for the user identifier. These statistics are kept hot and up to date as transactions are processed.

As mentioned above, the persistence is achieved by a data grid which is coordinated by a persistence layer 406. Geographic reach of the data grid together with a data grid provide internal replication in real-time to both the intra and inter grid members. The data grid will be built to ensure a deterministic N+1 or better redundancy. This will allow the data grid to autonomously recover from component failures, sacrificing neither the data quality nor the data reliability. Persistence applies to entities that need to be persisted and entities that need to be accessible for all of above to work.

The hub 110 applies a shared nothing architecture. In order to achieve higher resilience and availability, non-blocking and near linear performance scalability, the data grid nodes will make use of direct attached storage. This also removes any single points of contention and single points of failure from the persistence tiers. This also reduces complexity in design by removing the need for Storage Area Network (SAN).

The data within the hub 110 needs to be consistent across all data centres. This requires data to be distributed as the data changes as part of various transaction flows. Within a transaction flows there are pre-defined commit points where recoverability and consistency is ensured. For example, for a transaction, at some key points the system ensures that data is also at the oilier data centre. These two points are synchronous. Replication and data distribution within this transaction flow may be asynchronous.

The hub 110 further comprises a document processing layer 408. The hub 110 will be processing documents, such as bills, included as attachments, including non value instructions. This will be invoked as part of 3, 4 party patterns where a document or uniform resource locator (URL) or uniform resource identifier (URI) is attached to the message.

The hub 110 further comprises a security layer 409. The security layer 408 performs identity and access management employing a multi-factor authentication subsystem, a Certification Authority (CA) component and a role based access control subsystem. The multi-factor authentication subsystem provides strong authentication and integration with the federation components for admin and operator authentication and access control. The CA component provides X.509 certificate provisioning and management facility. The CA also provides a Certificate Revocation List (CRL) and Online Certificate Status Protocol (OCSP) services to ascertain validity/currency of X.509 certificates as part of the mutual authentication flow. The role based access control sub system will link identity to entity and their roles and access rights.

The security layer 408 also performs Security Incident and Events Management (STEM), exception handling and management. To perform these tasks the security layer 408 employs logging components and correlation engines. The logging components provide a centralised facility to log all the messages and events, including network devices, security devices and services. This information can be used to debug and trace events and correlations between various events. The correlation engines are used to identify related events, patterns for security and other compliance escalations.

The security layer 409 also performs operational monitoring and maintenance, such as vulnerability assessment including intrusion detection and internal and external vulnerability scanning,

Further, the hub 110 comprises a monitoring layer 610. As part of the handover to Technology Operations and production readiness five scenarios will be tested to meet the integrity and recoverability targets:

deep polling and synthetic transactions;

split-brain;

recovery;

cold boot; and

application maintenance and upgrades.

Split-brain can happen if one data centre hosting the hub 110 loses visibility to the other data centre and as a result islands itself. This may force each data centre to autonomously infer that it is the last surviving node and the other node is down. Automatic detection of split-brain using third party quorum, majority detection which would result in one of the two data centres to be taken down as active to pending consistency status.

Following steps are included in the technical solution to reduce likelihood of a split-brain.
use of two Telco carriers with no shared elements between the carriers.
each link will be provided with redundant path and redundant presentation. Use of technologies such as fully protected Synchronous Digital Hierarchy (SDH) ring allows recovery to alternate path in milliseconds.
ability to achieve quorum via links to networks for the transmission of clearing and settlement transactions such as the Community of Interest Network (COIN) of the Australian Payments Clearing Association (APCA), Internet and out of band (OOB) management. Links will allow detection of the loss of inter data centre carriage.

Recovery of a data centre from a planned or unplanned outage needs to automatically trigger background data sync and only bring a data centre/stack online once their state is consistent with rest of the hub 110. Recovery comprises the key features of
identifying the need for recovery,
isolating the data sets pending recovery/re-sync and
testing for completeness and correctness of recovery/sync.

A cold boot occurs in an extreme case, if the hub 110 and all its data centres are taken offline. Automation will be in place for a cold boot scenario.

The layering of applications within the hub 110 in this form allows for seamless horizontal and vertical scalability by bolstering components at each layer as required. This specific design also assists in managing performance and service levels and helps in limiting the impact of changes which will be required during the lifecycle of the hub 110. As a result, the overall maintainability, scalability and in turn availability of the hub 110 is improved. For example, introduction of messaging based on the Advanced Message Queuing Protocol (AMQP) will only require additions to the integration layer 401 and mediation layer 404.

In one example, the message from the biller including the communication address and the billing data arrives at the hub 110 as an encrypted Extensible Markup Language (XML) message. In another example the message comprises this data as comma separated values (CSV) and is transmitted using secure file transfer protocol (SFTP). The message is received by a web service of the integration layer 401. In other examples the message is received via an encrypted channel, such as IPsec, between the biller FI 108 and the hub 110. The integration layer 401 sends a transport level acknowledgment to the biller FI 108.

The message is handed over to the mediation layer 404, which converts the message from the outside schema to an inner schema. The mediation layer 404 converts messages from various different protocols into the same inner schema. Now that the message is in a suitable format for internal layers, it is forwarded to the application switching layer 402. The application switching layer 206 validates the encryption of the message including the validity of the key and routes the message to the appropriate module of the services layer 405.

In a different example, the integration layer 401, mediation layer 404 and application switching layer 402 are combined into a communication and mediation layer. This communication and mediation layer may act as an input and then receives an input message from an external sender, validates the input message and sends the input message to the internal service layer 405. This communication and mediation layer may also act as an output and receive an output message from the internal service layer 405 and send the output message to an external receiver.

The services layer 405 orchestrates the communication pattern that is used for associating the communication address with the payer FI 104. As mentioned above, the service layer 405 is stateless and therefore, the services layer 405 instructs the events processing layer 407 to initiate a state machine according to a predefined communication pattern. This state machine information needs to be persistently stored in a transaction table in the persistence layer 406 even in the event of a failure of an entire data centre, such as in case of a natural disaster. Therefore, at this stage, the state machine information is duplicated to a second data centre in sufficient geographical distance from the first data centre. The same storage requirement applies for changes to the association of the payer identifier to a communication addresss. The further processing of the request waits for the completion of the storing at the second data centre.

Once the state machine is initiated and made durable, the services layer 405 can query the state machine for the next step. In this case, the next step is to create a billing records message for the payer FI. This message passes the application switching layer 402, the mediation layer 404 and the integration layer 401 And is sent 122 to the payer FI 104. This starts a timer to detect a time out of the response of the payer FI 104. After technical validation by the payer FI 104, the integration layer 401 receives a response message acknowledging the correct transmittal of the billing records message. This acknowledgement is passed to the mediation layer 404 to further monitor the responsiveness of the payer FI 104.

Once the payer FI 104 generates a confirmation and sends it to the hub 110, the confirmation is received by the integration layer 401 and passes through the mediation layer 404 and the application switching layer 402 to the services layer 405. Receiving the confirmation prompts the services layer 405 to advance the state machine in the event processing layer 407 to the next state. As mentioned previously, the state of the state machine is persistent and therefore, the duplication of the state change to a second data centre is again performed.

After this step of advancing the state machine, the services layer 405 interacts with the persistence layer 406 to associate the communication address to the biller identifier and customer identifier. Then, the service layer generates a confirmation message for the biller FI 108. This message passes through the application switching layer 402, the mediation layer 404 and the integration layer 401. The confirmation message is then sent to the biller FI 108,

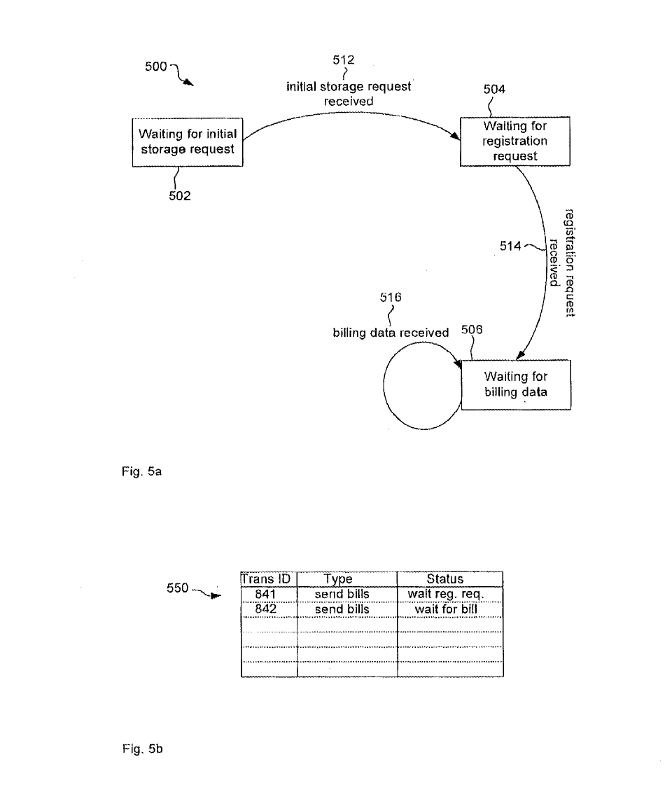

FIG. 5a illustrates a state transition diagram 500 for the state machine stored in the persistence layer. Registrations are associated with a specific registration transaction via the transaction identifier as described above. In turn, each registration transaction is associated with one state machine. As a result, when receiving a message related to a specific transaction the service layer can access the state machine and the current state stored in the persistence layer 406 for that transaction.

The state transition diagram 500 comprises three states, waiting for initial storage request 502, waiting for registration request 504 and waiting for billing data 506.

After initialisation the current state of the state machine is waiting for initial storage request 502. In a different example, the state machine is not initialised before an initial storage request is received. As a result, the state of waiting for initial storage request is not required in that example.

The communication and mediation layer as described above receives an input message from a sender, validates the input message and sends the input message to the service layer 405. Examples of validation are described above.

In a first case the input message is an initial communication address storage request. In this case the service layer 405 determines the payer identifier, the payer FI and the communication address based on the input message and stores in the persistence layer the communication address associated with the payer identifier and the payer FI. Then, the service layer 405 creates a state machine associated with the transaction identifier from the message. The predetermined state transition logic present in the state machine causes the current state stored in the persistence layer 406 to be advanced 512 to waiting for registration request from the biller 504.

In a second case the input message comprises a registration request from the biller 106 including a communication address and a customer identifier and the current state of the state machine associated with the transaction identifier from the message is waiting for registration request 504. In this case the service layer 405 determines the payer FI based on the communication address in the registration request and based on information stored in the persistence layer 406. The service layer 405 further stores in the persistence layer an association between the customer identifier and the payer FI.

The service layer 405 may then create an output message having the payer FI 104 as recipient. This output message including the registration request causes the payer FI 104 to also log the registration. The service layer 405 then sends the output message to the communication and mediation layer. The predetermined state transition logic present in the state machine causes the current state stored in the persistence layer 406 to be advanced 514 to waiting for billing data 506.

In a third case the input message comprises billing data from the biller and the current state of the state machine associated with the transaction identifier from the message is waiting for billing data 506. In this case the service layer 405 determines the payer FI associated with the communication address in the persistence layer.

Then, the service layer 405 creates the output message having the payer FI as recipient and including the billing data. The service layer 405 sends the output message to the communication and mediation layer. The predetermined state transition logic present in the state machine causes the current state stored in the persistence layer 406 to be advanced 716 back to the same state of waiting for billing data 506.

FIG. 5b illustrates a transaction table 550. The transaction data table 550 stores data related to transactions which are currently pending. In this example, for transaction 842 hub 110 is waiting for an registration request including the communication address from the biller 106. The hub 110 creates a new entry when the state machine is created. When the transaction is finished, the entry in the transaction table 840 is deleted.

It will be appreciated by persons skilled in the art that numerous variations and/or modifications may be made to the invention as shown in the specific embodiments without departing from the scope of the invention as broadly described.

It should be understood that the techniques of the present disclosure might be implemented using a variety of technologies. For example, the methods described herein may be implemented by a series of computer executable instructions residing on a suitable computer readable medium. Suitable computer storage is readable media may include volatile (e.g. RAM) and/or non-volatile (e.g. ROM, disk) memory, carrier waves and transmission media. Exemplary carrier waves may take the form of electrical, electromagnetic or optical signals conveying digital data streams along a local or wide area network or a publicly accessible network such as the internet.

It should also be understood that, unless specifically stated otherwise as apparent from the following discussion, it is appreciated that throughout the description, discussions utilizing terms such as “receiving”, “sending”, “processing” or “computing” or “calculating”, “optimizing” or “estimating” or “determining” or “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments arc, therefore, to be considered in all respects as illustrative and not restrictive.

1. A computer implemented method for sending bills from a biller to a payer, the method comprising:
receiving from the biller a communication address and billing data;
determining based on the communication address a payer identifier and a payer institution; and
sending the billing data associated with the payer identifier to the determined payer institution.

2. The method of claim 1, further comprising:
receiving from the biller a customer identifier; and
storing an association between the payer identifier, payer institution and the customer identifier to allow the biller to provide billing data associated with the customer identifier to the payer through the billing services hub.

3. The method of claim 2, further comprising
receiving from the biller a biller identifier,
wherein storing the association comprises storing an association of the payer identifier, payer institution and the customer identifier with the biller identifier.

4. The method of claim 3, further comprising sending to the payer institution a registration confirmation message comprising the payer identifier, the customer identifier and the biller identifier.

5. The method of claim 1, wherein receiving the communication address comprises:
receiving a billing data message comprising a payer identifier field; and
determining the communication address based on a value of the payer identifier field.

6. The method of claim 5, further comprising:
detecting an indicator that the value of the payer identifier field comprises a communication address; and
selectively determining the communication address where the indicator is identified.

7. The method of claim 1, further comprising:
receiving a communication address from the payer associated with a payer identifier and a payer institution; and
storing an association between the payer identifier, the payer institution and the communication address.

8. The method of claim 7, further comprising:
determining whether the communication address received from the payer is already stored; and
selectively performing the step of storing the association where the communication address is not already stored.

9. The method of claim 7, wherein
receiving the communication address from the payer comprises receiving a biller registration request message from the payer comprising a biller identifier field, and
the method further comprises selectively performing the step of storing the association between the payer identifier, the payer institution and the communication address based on a value of the biller identifier field.

10. The method of claim 7, wherein receiving the communication address from the payer comprises:
receiving a biller registration request message from the payer comprising a customer identifier field; and
determining the communication address based on a value of the customer identifier field.

11. The method of claim 7, further comprising sending a confirmation message to the payer institution that the communication address has been stored.

12. A non-transitory computer readable medium with an executable program stored thereon that when executed causes a computer to perform the method of claim 1.

13. A computer implemented billing services hub for sending bills from a biller to a payer, the billing services hub comprising:
an input port to receive from the biller a communication address and billing data;
a processor to determine based on the communication address a payer identifier and a payer institution; and
an output port to send the billing data associated with the payer identifier to the determined payer institution.

14. A billing services computer system for controlling sending of bills, the billing computer system comprising:
a persistence layer to store a status for the sending of bills and user data including a payer identifier, communication address and associated payer financial institution (FI);
a communication and mediation layer to receive an output message from a service layer, to send the output message to a recipient, to receive an input message from a sender, to validate the input message and to send the input message to the service layer; and
the service layer
to receive the input message from the communication and mediation layer,
where the input message includes an initial communication address storage request, to determine the payer identifier, the payer FI and the communication address based on the input message, to store in the persistence layer the communication address associated with the payer identifier and the payer FI and to set the status in the persistence layer to waiting for registration request from a biller,
where the status is waiting for registration request from a biller and the input message comprises a registration request from the biller including a communication address and a customer identifier, to determine the payer FI based on the communication address in the registration request and based on information stored in the persistence layer, to store in the persistence layer an association between the customer identifier and the payer FI and to set the status in the persistence layer to waiting for billing data, and
where the status is waiting for billing data and the input message comprises billing data from the biller, to determine the payer FI associated with the communication address in the persistence layer, to create the output message having the payer FI as recipient and including the billing data, and to send the output message to the communication and mediation layer.
